(19) United States
(12) Patent Application Publication
(10) Pub. No.: US 2019/0267586 A1
(43) Pub. Date: Aug. 29, 2019

(54) Coin Cell Battery Housing

(71) Applicant: HEWLETT PACKARD ENTERPRISE DEVELOPMENT LP, Houston, TX (US)

(72) Inventors: Kevin Conn, Houston, TX (US); Chanh V Hua, Houston, TX (US)

(21) Appl. No.: 16/318,133

(22) PCT Filed: Jul. 29, 2016
(86) PCT No.: PCT/US2016/044869

§ 371 Date: Jan. 15, 2019

(51) Int. Cl. H01M 2/10; H01R 12/70; H01R 12/71; H01R 13/502

(52) U.S. Cl. CPC H01M 2/1044; H01R 12/7088; H01M 2220/30; H01R 13/502; H01R 12/716

(57) ABSTRACT

Examples described herein relate to coin cell battery housing. In one example, a device for housing a coin cell battery includes a receptacle to receive the coin cell battery, a connector to couple the device to an electronic board, and a hinge to couple the receptacle to the connector. The hinge is to allow rotation of the receptacle in a horizontal position and a vertical position, where in the horizontal position, a gap is maintained between the receptacle and the board such that a component can be mounted on the board under the receptacle.

### BACKGROUND

A watch battery or button cell is a small single cell battery shaped as a squat cylinder (or puck) typically 5 to 25 mm in diameter and 1 to 6 mm high, and are used to power mall portable electronics devices such as wrist watches, pocket calculators, artificial pacemakers, hearing aids, and the like. Thinner variants are usually called coin cells. Coin cell batteries are used to power or provide backup power to computers, microprocessors, and other electronic components and systems. Typically, these batteries are disk-shaped and relatively small, for example, having a diameter of about 0.268 inches and a thickness of about 0.083 inches.

### BRIEF DESCRIPTION OF THE DRAWINGS

Some examples of the present application are described with respect to the following figures:

FIG. 1 is an isometric view of a device for housing a coin cell battery, according to an example;

FIG. 2 is an isometric view of the device mounted on an electronic board with a coin cell receptacle of the device rotated in a horizontal position, according to an example;

FIG. 3 is an isometric view of the device mounted on the electronic board with the coin cell receptacle rotated in a vertical position, according to an example;

FIG. 4 is a side view of the device mounted on the electronic board with the coin cell receptacle rotated in the horizontal position, according to an example;

FIG. 5 is a side view of the device mounted on the electronic board with the coin cell receptacle rotated a few degrees, according to an example; and

FIG. 6 is a side view of the device mounted on the electronic board with the coin cell receptacle rotated in the vertical position, according to an example.

### DETAILED DESCRIPTION

Examples described herein relate to a device for housing a coin cell battery. As the size of electronic devices continues to shrink in size, the demand for small thin-sized batteries increases. Accordingly, there is a need for coin cell battery holders (or housing) that meet the increasing space constraints of electronic boards onto which the coin cell batteries are mounted. It is desirable that a coin cell battery housing takes up a minimum footprint on the electronic board, be easy to mount, and be readily accessible for replacing the coin cell. Existing coin cell battery holders that mount horizontally take up too much room on the electronic board, and holders that mount vertically require too much height and may increase an overall height of the electronic device onto which it is installed.

Examples described herein address the above challenges by providing a rotating coin cell receptacle that can rotate to a vertical position and a horizontal position and take up a minimal or least amount of space on the electronic board. In the horizontal position, a gap is maintained such that components can be mounted on the electronic board at the space underneath the receptacle. Further, the receptacle can rotate to the vertical position, taking up minimal vertical space, and providing access to the components and test pads under the receptacle.

In one example, a device for housing a coin cell battery includes a receptacle to receive the coin cell battery, a connector to couple the device to an electronic board, and a hinge to couple the receptacle to the connector. The hinge is to allow rotation of the receptacle in a horizontal position and a vertical position, where in the horizontal position, a gap is maintained between the receptacle and the board such that a component can be mounted on the board under the receptacle.

In another example, an electronic board includes a plurality of components mounted on the board and a device to house a coin cell battery. The device includes a receptacle portion to receive the coin cell battery, a connector portion to couple the device to the board, a hinge portion to facilitate positioning of the receptacle portion in: a substantially horizontal position such that a gap is maintained between the receptacle portion and the board, the gap sufficient to fix at least a component of the plurality of components on the board at a location under the receptacle portion; and a substantially vertical position.

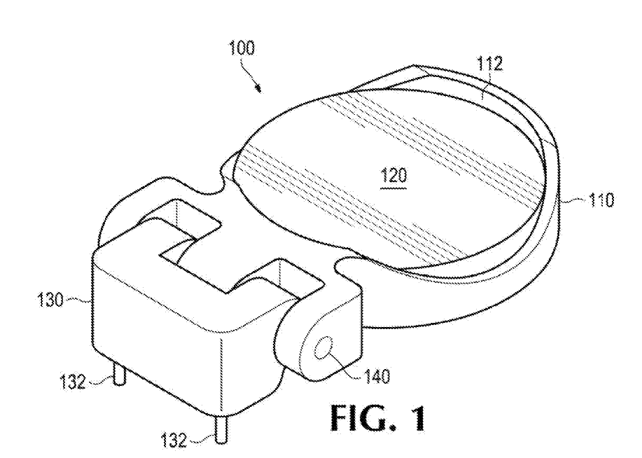

FIG. 1 is an isometric view of a device for housing a coin cell battery, according to an example. Device 100 includes a receptacle 110 to receive a coin cell battery 120, a connector 130 to couple the device to an electronic board, and a hinge to couple the receptacle 110 to the connector 130. The hinge 140 allows rotation of the receptacle 110 between a vertical position and a horizontal position. Device 100 can be formed of plastic or any other non-conducting material.

Receptacle 110 can include a base plate (not shown) and at least one sidewall 112 extending upwards from the base plate such that the base plate and the at least one sidewall 112 define a cavity for receiving the coin cell battery 120. In some examples, coin cell battery 120 is a lithium-ion or lithium polymer single cell battery shaped like a disk or puck that can be used to provide power or backup power in low drain rate applications (e.g., memory backup), or thin devices. However, examples are not limited to lithium-based materials. The size of the coin cell battery 120 is indicated by convention using a 4-digit designation where the first two digits represent a diameter in millimeters (mm) and the last two digits represent a height/thickness times 10 in mm. For example, a 2320 coin cell is 23 mm in diameter and 2.0 mm in height or thickness. In some instances, the 4-digits may be prefixed by two letters representing a manufacturer of the coin cell battery 120. The base plate of the receptacle 110 can include an electrical contact to engage with the coin cell battery 120 when the coin cell battery 120 is inserted into the receptacle 110.

The connector 130 can include a plurality of pins 132 to electrically couple the device 100 to an electronic board (not shown). Pins 132 can include a positive terminal and a negative terminal. In some examples, connector 130 can include a single pin to electrically couple the device 100 to the electronic board. The electrical contact of the base plate of the receptacle 110 is thereby electrically coupled to the electronic board via the connector 130 (i.e., through the pins 132 of the connector 130). Accordingly, electrical contact, and transfer of power from the coin cell battery 120, is made from the electrical contacts of the receptacle 110 through the pins 132 of the connector 130 onto the board.

Hinge 140 provides a mechanism for the receptacle 110 to rotate between the horizontal position and the vertical position. In other words, the receptacle 110 can rotate about the connector 130 via the hinge 140. In the horizontal position, a gap is maintained between the receptacle 110 and the electronic board such that one or more components, or portions of the one or more components, can be mounted onto the electronic board at a location under the receptacle 110 (i.e., under the coin cell battery 120). The components can be accessible from under the receptacle 110 by rotating the receptacle 110 to the vertical position.

In certain examples, the device 100 is configured such that a height/thickness of the receptacle 110 is less than a height/thickness of the connector 130. Moreover, the receptacle 110 is coupled to the connector 130 via the hinge 140 such that the gap is maintained between the base of the receptacle 110 and the electronic board. Further, the receptacle 110 may not rotate past a certain degree such that the receptacle 110 does not touch a surface of the electronic board, or such that the gap is not reduced. As described herein, the gap represents a threshold height of the base of the receptacle from a surface of the electronic board when the receptacle 110 is in the horizontal position or a distance between the base of the receptacle 110 and the surface of the electronic board when the receptacle 110 is in the horizontal position. In some examples, the gap is at least 1 mm and up to 2 mm. However, examples are not so limiting. As a result of the described solution, electronic board space can be maximized by allowing components to be mounted on the electronic board at spaces under the coin cell battery receptacle, and providing access to the components by rotating the receptacle 110 to a vertical position.

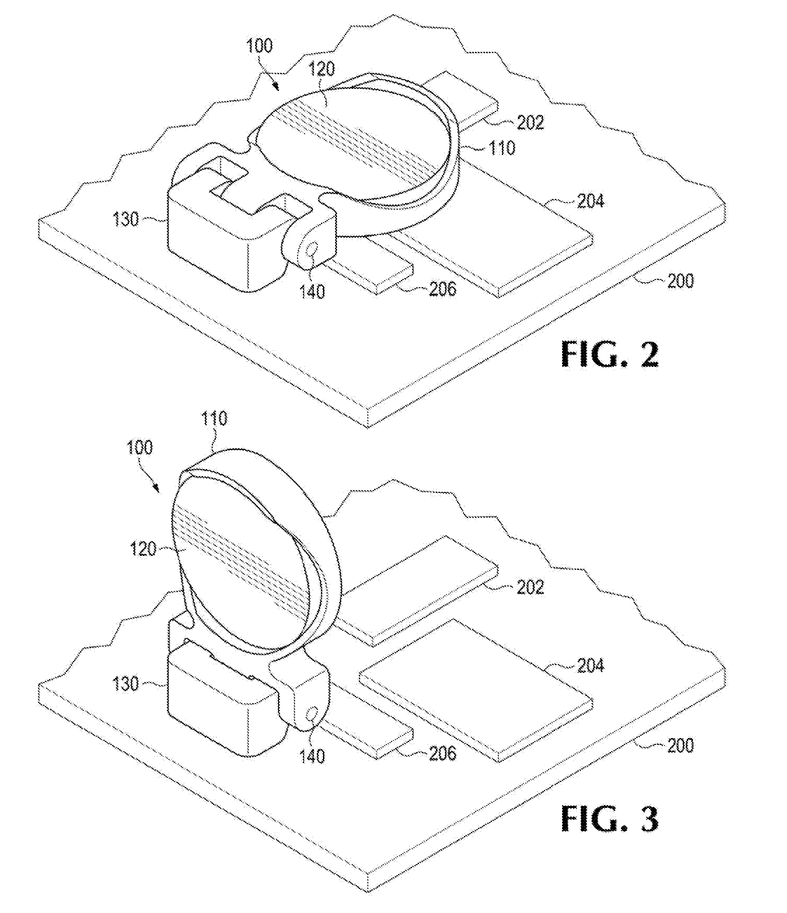

FIG. 2 is an isometric view of the device mounted on an electronic board with a coin cell receptacle of the device rotated in a horizontal position, according to an example. In the example of FIG. 2, the receptacle 112 housing the coin cell battery 120 is in the horizontal position. Device 100 is mounted or coupled to the electronic board 200 via the connector 130. Electronic board 200 can be a printed circuit assembly (PCA), a printed circuit board (PCB), a motherboard, a memory board, an input/output board, and the like. Electronic board 200 can be mounted on the chassis of a computing system or electronic device.

A number of components including device 100 can be mounted on the board 200 via electrical contacts. For example, components 202, 204, and 206 can also be mounted on the board 200. Components 202-206 can include memory devices, processors, integrated circuits, and other surface-mount devices. When the receptacle 110 is in the horizontal position, components 202-206 can still be mounted on the board 200 at locations under the receptacle 110, thereby maximizing the board space. As described, when the receptacle 110 is placed in the horizontal position, a gap is maintained between the receptacle 110 and the board 200 such that the components 202-206 can occupy spaces under the receptacle 110.

FIG. 3 is an isometric view of the device mounted on the electronic board with the coin cell receptacle rotated in a vertical position, according to an example. In the example of FIG. 3, the receptacle 110 is placed in the vertical position by rotating the receptacle 110 about the hinge 140 while the device 100 is mounted on the board 200 via the connector 130. In the vertical position, components 202-206 are accessible and can, therefore, be removed or placed on the board 200.

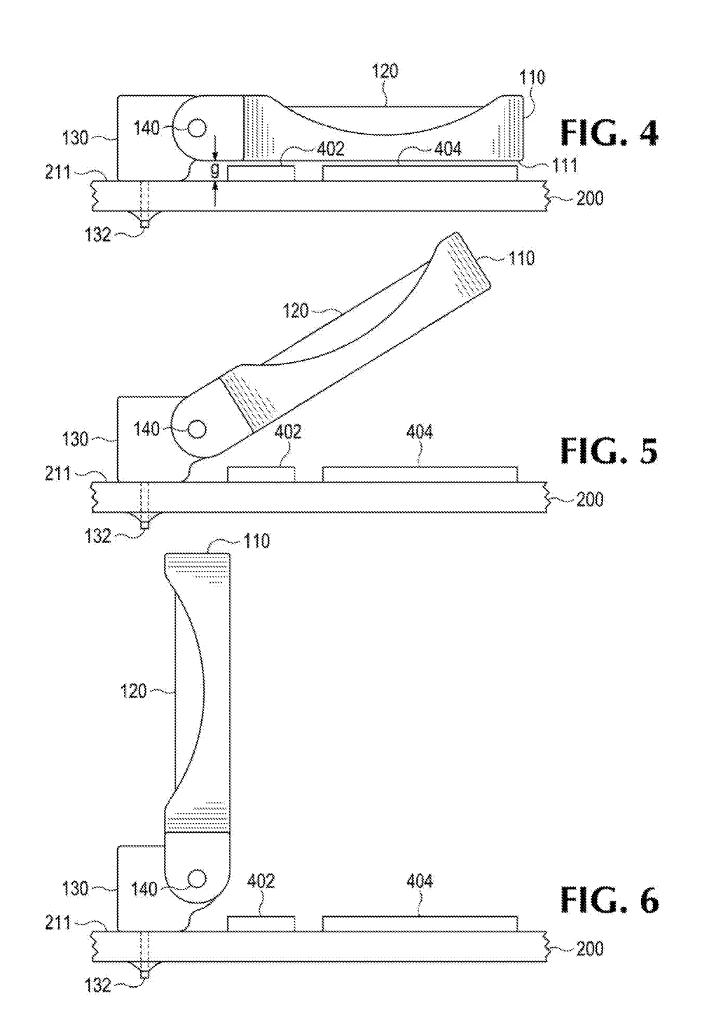

FIG. 4 is a side view of the device mounted on the electronic board with the coin cell receptacle rotated in the horizontal position, according to an example. In the example of FIG. 4, the receptacle 110 is in the horizontal position. In this orientation, a gap g is maintained between the receptacle 110 and the board, such that components 402 and 404 can occupy a position on the board 200 under the receptacle 110. In particular, gap g is a height between the base 111 of the receptacle 110 and a surface 211 of the board 200. Device 100 is configured such that the receptacle 110 may not rotate about the hinge 140 to touch the surface 211 of the board 200, or such that the gap g is not below a certain threshold height. In certain non-limiting examples, the gap g is at least 1 mm but no more than 2 mm.

FIG. 5 is a side view of the device mounted on the electronic board with the coin cell receptacle rotated a few degrees, according to an example. In the example of FIG. 5, the receptacle 110 is rotated to a position between the horizontal position and the vertical position. In other words, the receptacle 110 is rotated at an angle between zero degrees (i.e., the horizontal position) and ninety degrees (i.e. the vertical position) from the gap g. Rotation of the receptacle 100 between the horizontal position and the vertical position provides access to the components 402 and 404.

FIG. 6 is a side view of the device mounted on the electronic board with the coin cell receptacle rotated in the vertical position, according to an example. In the example of FIG. 6, the receptacle 110 is rotated to the vertical position (e.g., 90 degrees) to provide access to the components 402 and 404.

In the foregoing description, numerous details are set forth to provide an understanding of the subject matter disclosed herein. However, implementations may be practiced without some or all of these details. Other implementations may include modifications and variations from the details discussed above. It is intended that the following claims cover such modifications and variations.

What is claimed is:

1. A device for housing a coin cell battery, comprising:
a receptacle to receive the coin cell battery;
a connector to couple the device to an electronic board; and
a hinge to couple the receptacle to the connector, the hinge to allow rotation of the receptacle in a horizontal position and a vertical position,
wherein in the horizontal position, a gap is maintained between the receptacle and the board such that a component can be mounted on the board under the receptacle.

2. The device of claim 1, wherein in the vertical position the component is accessible from the board.

3. The device of claim 1, wherein the connector includes a plurality of pins to electrically couple the device to the board and wherein the plurality of pins include a positive terminal and a negative terminal.

4. The device of claim 1, wherein the hinge is to allow rotation of the receptacle between the horizontal position and the vertical position.

5. The device of claim 1, wherein the receptacle includes a base plate and at least one sidewall extending from the base plate, and wherein the base plate and the at least one sidewall define a cavity for receiving the coin cell battery.

6. The device of claim 5, wherein the base plate includes an electrical contact to engage with the coin cell battery when the coin cell is inserted in the receptacle.

7. The device of claim 6, wherein the electrical contact is electrically coupled to the board via the connector.

8. The device of claim 1, wherein a height of the receptacle is less than a height of the connector.

9. The device of claim 1, wherein the coin cell battery is to provide power to at least the board and the component.

10. An electronic board, comprising:
a plurality of components mounted on the board; and
a device to house a coin cell battery, comprising:
a receptacle portion to receive the coin cell battery;
a connector portion to couple the device to the board; and
a hinge portion to facilitate positioning of the receptacle portion in:
a substantially horizontal position such that a gap is maintained between the receptacle portion and the board, the gap sufficient to fix at least a component of the plurality of components on the board at a location under the receptacle portion, and
a substantially vertical position.

11. The board of claim 10, wherein the plurality of components include surface mount components.

12. The board of claim 10, wherein the board includes a printed circuit assembly (PCA).

13. The board of claim 10, wherein the connector portion includes a plurality of pins to electrically couple the device to the board, and wherein the plurality of pins include a positive terminal and a negative terminal.

14. The board of claim 10, wherein the receptacle portion includes a base plate and at least one sidewall extending up from the base plate, the base plate and the at least one sidewall defining a cavity for receiving the coin cell battery.

15. The board of claim 10, wherein the base plate includes an electrical contact to engage with the coin cell battery when inserted into the receptacle.
